(19) United States
(12) Patent Application Publication
(10) Pub. No.: US 2010/0002202 A1
(43) Pub. Date: Jan. 7, 2010

(54) Configuration of an Optical Illumination System for Minimizing the Influence of Arc Deflections

(76) Inventors: Bärbel Dierks, Wandlitz (DE); Henning Rehn, Berlin (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/522,856

(22) PCT Filed: Jan. 10, 2007
(86) PCT No.: PCT/EP07/50202

§ 371 Date: Jul. 10, 2009

(51) Int. Cl. G03B 21/20; F21V 7/04; F21V 13/02

(52) U.S. Cl. 353/85; 362/277

(57) ABSTRACT

A method for reducing the effects of fluctuations in the light intensity of an effective light which is emitted by a discharge lamp, is focused by a reflector and is coupled into a light-collecting optical unit with a defined étendue at a defined acceptance angle. The method comprises the steps of: defining an effective luminous flux maximum depending on étendue, acceptance angle and/or reflector properties, and changing the reflector properties, the acceptance angle and/or the étendue in such a way that the effective luminous flux maximum is reduced by a definable percentage magnitude.

### TECHNICAL FIELD

The present invention relates to a method for reducing spatial fluctuations in the light intensity of a light which is emitted by a discharge lamp and is focused by a reflector, as well as to an optical system which is optimized in accordance with this method.

### PRIOR ART

In optical systems which collect the light from a discharge lamp which has been focused by a reflector in one spot, via an integrator such as a mixing rod, a fiber or a fly's eye condenser, for example, there is the problem that the Étendue of the integrator is often smaller than that of the lamp. As a result, less light can be coupled into the integrator than is actually available. In order to maximize this effective luminous flux, the optical unit is adapted in such a way that the selected acceptance angle and the coupling-in area collect a maximum magnitude of the light emitted by the lamp.

However, one problem here is the fact that the discharge arc produced by the discharge lamp is not fixed in space, but is subjected to spatial changes, for example owing to changes to the electrodes. These spatial changes are expressed in the case of a lamp with a reflector by the spot produced by the reflector likewise not assuming a steady position, but performing a fluctuating movement. If light from this spot is now coupled into an optical unit, the coupled-in luminous flux fluctuates owing to the spatial change.

In order to counteract this problem, modes of operation are known from the prior art which minimize the spatial fluctuations of the discharge arc (flicker). However, such methods only solve the problem of unsteadiness of the arc (flicker) gradually, or only over part of the life of a discharge lamp.

### DESCRIPTION OF THE INVENTION

The object of the present invention is therefore to provide a method as well as an optical system which reduces the effects of flicker on the effective light.

This object is achieved by a method and an optical system which is designed in accordance with this method, in which first the acceptance angle, Étendue and reflector design are adapted for a given system in such a way that the effective luminous flux is at a maximum, and then the reflector, acceptance angle and/or Étendue are changed in such a way that the effective luminous flux maximum is reduced by a defined percentage.

Here, a method will be described below which can be used to significantly reduce the effects of a residual or unavoidable arc movement on the effective light.

In most applications it is endeavored or intended to optimize the matching to the lamp (or to match the lamp to the optical system) and thus to maximize the collected luminous flux by virtue of a suitable design of the light-collecting optical system at a given étendue.

However, it has been shown that, precisely for the case of improved matching, the effects of the arc movements on the effective luminous flux are at a maximum and that this “flicker sensitivity” can be markedly reduced by slight mismatching.

In the case of an elliptical reflector, the change in the parameters and the reduction in the effective luminous flux quantity ultimately has the effect that the ratio of the area of the spot to the coupling-in area is reduced in size, with the result that the coupled-in quantity of light remains virtually constant even in the event of changes to the spot position. This is made possible by a reduction in the effective luminous flux.

Particularly advantageous in this case is an exemplary embodiment in which the light intensity maximum is reduced by 5-20%, in particular 8-12%.

This slight mismatching with a reduction in the effective luminous flux maximum can, as is demonstrated by further preferred exemplary embodiments, be achieved by a number of possible ways. Firstly, a further component with a larger coupling-in area and a smaller acceptance angle or, in the case of a parabolic reflector, an element with a reduced area and a larger acceptance angle which collects the light from the reflector and emits it to the actual optical unit can be connected upstream of the actual light-collecting optical unit. Particularly advantageous in this case is an exemplary embodiment in which the additional element is conical, with the result that the actual light-collecting optical unit can be connected directly thereto.

In another particularly preferred exemplary embodiment, the imaging properties of the reflector (numerical eccentricity) and/or light-collecting optical unit are changed in such a way that the reduction in the effective luminous flux maximum takes place. In particular, the changes to the imaging properties of the reflector have the significant advantage that already existing optical systems can easily be realized by using a lamp or reflector which is optimized in relation to this system.

On the other hand, the entrance area of the light-collecting optical unit can naturally also be changed, as a result of which the use of standard and therefore relatively favorable discharge lamps is possible without being faced with the problems of the prior art.

Particularly advantageous are exemplary embodiments in which the light-collecting optical unit is the optical unit of a DLP projector, a microscope or an endoscope.

Further advantages and preferred exemplary embodiments are defined in the dependent claims, the drawings and the description.

### BRIEF DESCRIPTION OF THE DRAWINGS

The invention will be explained below with reference to drawings, which represent particularly preferred exemplary embodiments and in which:

FIG. 1 shows an illustration of the shift in a spot, which is produced by the reflector, as a result of a lateral arc movement;

FIG. 2 shows a graphical representation of the relationship between the maximum effective luminous flux and the maximum flicker signal (=change in the effective luminous flux given a defined arc movement);

FIG. 3a shows a schematic illustration of an optical system comprising a lamp with an elliptical reflector and a fiber into which light is intended to be coupled in accordance with the prior art;

FIG. 3b shows an illustration of the optical system shown in FIG. 2a in accordance with a particularly preferred exemplary embodiment of the present invention;

FIG. 4 shows a graphical representation of a comparison of the influence of arc fluctuations on the light intensity;

FIG. 5 shows a graphical representation of the change in the flicker signal depending on the length of an upstream element according to the invention; and

FIG. 6 shows a schematic illustration of a DLP projector, which has been optimized in accordance with the method according to the invention.

### PREFERRED EMBODIMENT OF THE INVENTION

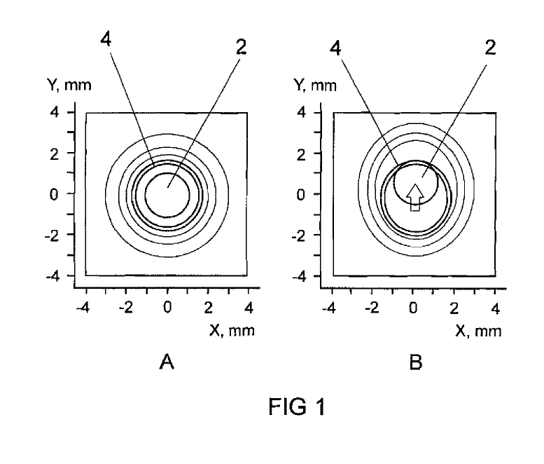

FIG. 1 shows a shift in a spot 2 represented by a reflector if a discharge arc moves laterally, i.e. in this case in the Y direction. The circle denoted by the reference symbol 4 indicates the area which is available to a light-collecting optical unit, into which the light of the spot is intended to be coupled, as the coupling-in area.

Normally, the acceptance angle and the coupling-in area 4 of the light-collecting optical unit at a given étendue are selected such that a maximum effective luminous flux results. This situation is illustrated in the illustration on the left-hand side in FIG. 1 denoted by A. If, however, the discharge arc of the lamp moves for example as a result of changes to the electrode, this naturally also brings with it a spatial movement of the spot. Such a lateral movement of the spot is illustrated in the illustration on the right-hand side in FIG. 1 denoted by B. A comparison of illustrations A and B clearly shows that the light intensity on the coupling-in area 4 is reduced since the spot has shifted slightly with respect to the coupling-in area owing to the movement of the discharge arc. This results in a change in the signal provided by the light-collecting optical unit. It has been shown here that the flicker signal is at a maximum when the coupled-in effective luminous flux is also at a maximum.

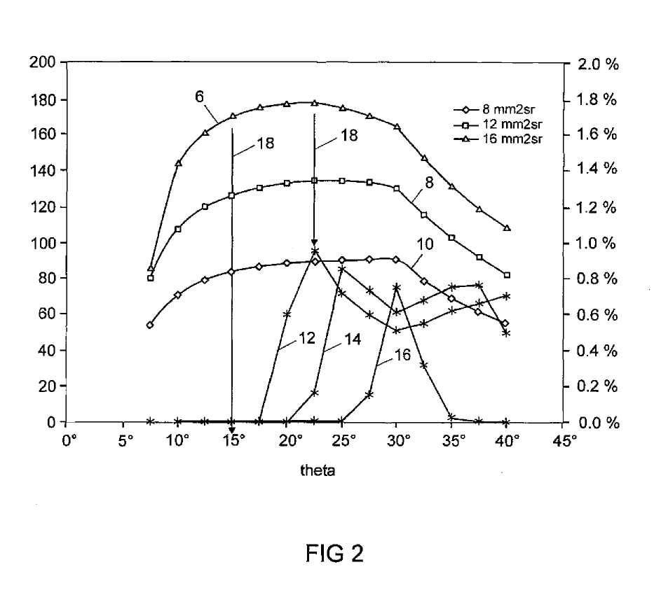

The relationship between the maximum flicker signal and the maximum effective luminous flux is shown graphically in FIG. 2. The graphs illustrated in FIG. 2 show the change in the effective luminous flux and the change in the flicker signal depending on an acceptance angle given a predetermined Étendue of the optical system. Graphs 6, 8 and 10 show the change in the effective luminous flux for three different Étendues of the optical system, with the acceptance angle θ being changed. Graphs 12, 14 and 16 show the changes in the flicker signal for the predetermined Étendues depending on the acceptance angle.

It can clearly be seen here that the maximum of the effective luminous flux graphs and the maximum of the flicker signal for the corresponding Étendues in each case coincide. Thus, the maximum of the effective luminous flux and the flicker signal for an Étendue of 16 mm²sr is approximately θ=22°, the maximum for an Étendue of 12 mm²sr is approximately θ=24° and the maximum for an Étendue of 8 mm²sr is approximately θ=30° (acceptance angle in each case).

If the reduction in the effective luminous flux by a defined percentage in accordance with the invention is accepted, a virtually complete reduction in the flicker signal is achieved. This is illustrated by the arrows 18 in FIG. 2. At an Étendue of 16 mm²sr (cf. graphs 6 and 12), a reduction in the effective luminous flux by approximately 10% results in virtually complete extinguishing of the flicker signal. For this purpose, only the acceptance angle needs to be changed from θ=22° to θ=15°.

A change to the area and/or acceptance angle can be realized in an optical system which comprises a discharge lamp with a reflector and a downstream light-collecting optical unit, for example, by virtue of the fact that a further element whose area/acceptance angle is selected to be different at the same Étendue is introduced upstream of the light-collecting optical unit.

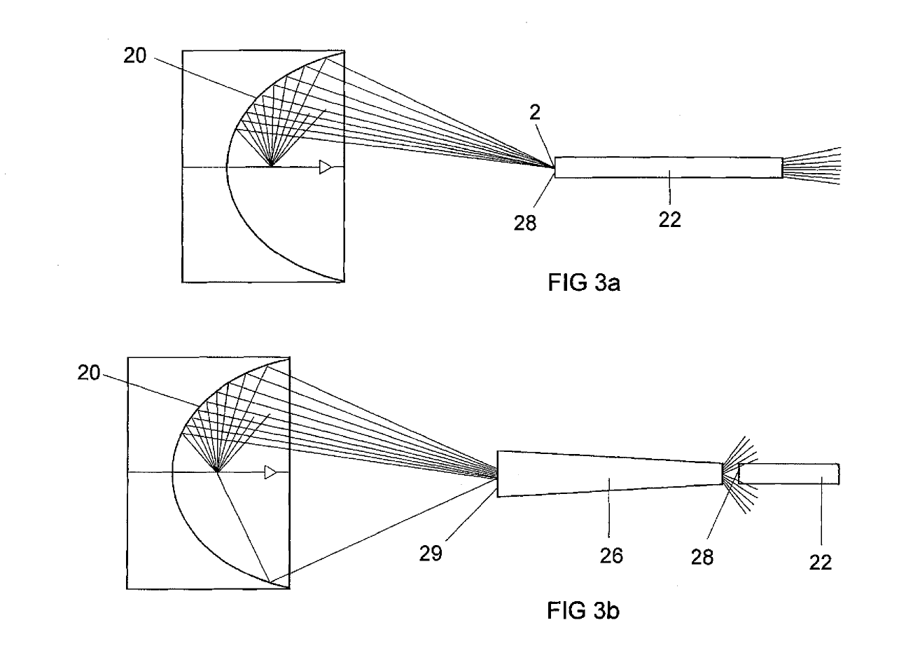

Such an optical system is illustrated in FIGS. 3a and 3b. The figures show an elliptical reflector 20, which focuses light from a discharge lamp (not explicitly illustrated here) in a spot 2. The coupling-in area 28 of a light-collecting optical unit 22, which in this case is in the form of an optical fiber, is arranged at the spot 2. In the example illustrated here, an optical waveguide with a radius of 1.5 mm is used, for example, as the optical fiber, which optical waveguide collects light with an acceptance angle of θ=30° from the elliptical reflector.

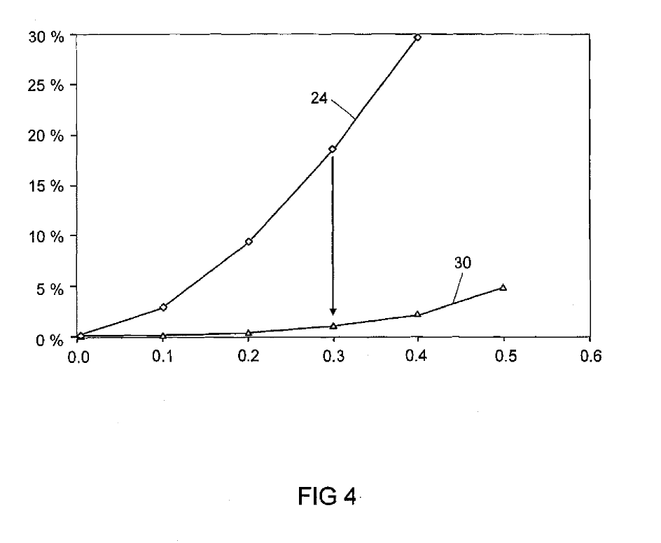

This exemplary embodiment shows a dependence between the discharge arc shift (x axis) and the flicker signal (y axis), as is illustrated by graph 24 in FIG. 4.

Using the method according to the invention, the optical system is optimized by virtue of the fact that the reflector, the Étendue or the acceptance angle is changed. If the intention is to continue to use a standard lamp, a change to the reflector is not possible. This means that only the Étendue or the acceptance angle in the optical unit can be changed. Correspondingly, an element whose entrance area is increased in size in comparison with the actual light-collecting optical unit, but whose acceptance angle is reduced in size, with the Étendue remaining constant, can be connected upstream of the light-collecting optical unit shown in FIG. 3a, for example.

FIG. 3b shows an optical unit according to the invention, in which a conically tapering glass body 26 is connected upstream of the light-collecting optical unit 22. In this case, a straight glass body or else a glass body with parallel walls can naturally be used instead of a conically tapering glass body. It is merely critical that a coupling-in area 29 of the glass body 26 is larger than the coupling-in area 28 of the original light-collecting optical unit 22. As a result of the extension of the angular distribution of the light in the conically tapering glass body beyond the original acceptance angle, the percentage reduction in the effective luminous flux results owing to the relationship R₁ sin θ₁=R₂ sin θ₂, where R describes the coupling-in area and θ describes the acceptance angle. The conical tapering of the glass body merely represents a simple solution for making it possible to couple the original light-collecting optical unit, i.e. the optical waveguide, in a simple manner.

FIG. 4 shows, in graph 30, the fact that the flicker signal has been markedly reduced in this arrangement in comparison with the flicker signal of the arrangement from the prior art (cf. graph 24 in FIG. 4), but with only a reduction in the effective luminous flux of approximately 10% needing to be accepted.

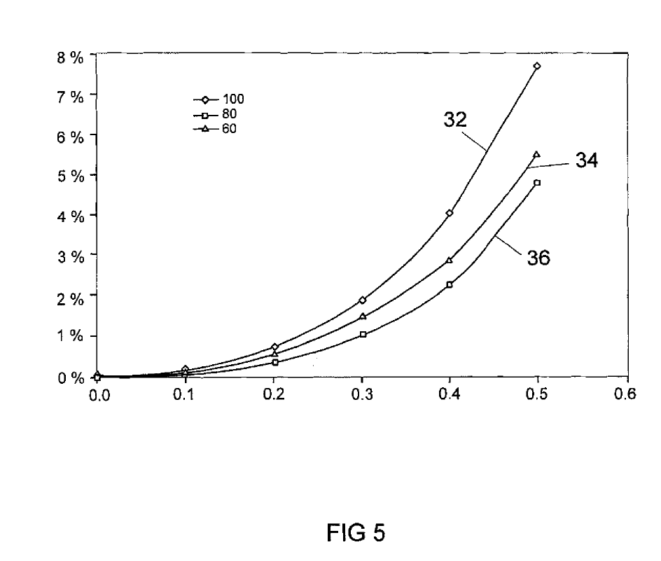

One disadvantage with this system is naturally the fact that, owing to the upstream component, the optical system is increased in size. However, if further losses in terms of the effective luminous flux are accepted, the length of the additional component can also be markedly reduced without needing to dispense with the reduction in the flicker signal. The dependence between the discharge arc shift (x axis) and the flicker signal (y axis) taking into consideration the length of the glass body 26 is illustrated in FIG. 5. In this case, the flicker reducing effect of the conical glass body reduces with the length thereof (cf. graphs 32, 34, 36).

Instead of the elliptical reflector illustrated in FIGS. 3a/3b, a parabolic reflector can naturally also be used. Here, it is clear that in this case the coupling-in area needs to be reduced in size and the acceptance angle needs to be increased in size. When using a lamp with a parabolic reflector and fly's eye condensers, the downstream relay optical unit can easily be designed in such a way that a larger angular range is accepted. This is primarily advantageous for optical systems such as LCD or LCOS projectors.

In order to achieve the same effect, it is naturally also possible for the reflector itself to be changed, i.e. in the case of the elliptical reflector the optimum eccentricity calculated depending on the acceptance angle is reduced in size in accordance with the invention. The change to an elliptical reflector depending on the Étendue and acceptance angle is described, for example in the document DE 10 2004 032 406.

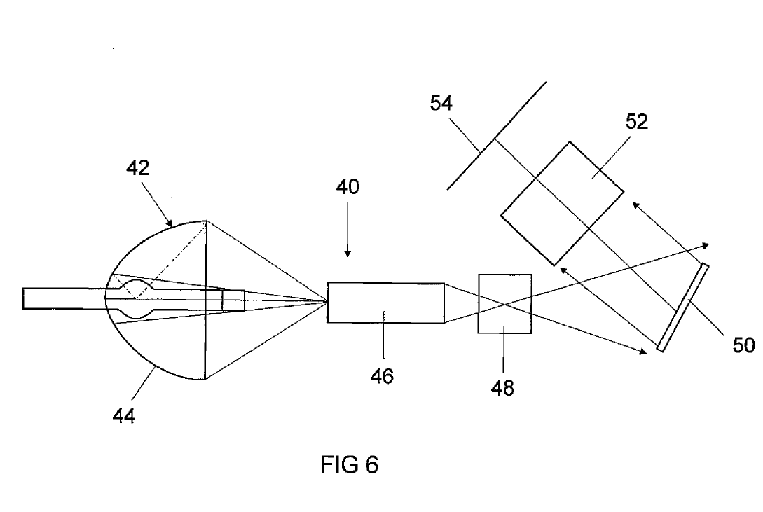

FIG. 6 shows, schematically, the basic design of a DLP projector, which has been optimized corresponding to the method. The optical system of the projector 40 substantially comprises a discharge lamp 42 with an elliptical reflector 44, an integrator 46, a relay optical unit 48, a DMD chip 50 and a lens 52. The light produced by the discharge lamp 42 and focused by the reflector 44 is coupled into the integrator 46 and made uniform by multiple reflection. Then, the light is coupled into the relay optical unit 48 and imaged onto the DMD chip 50. A large number of pivotable micromirrors, which produce an image pixel or remain dark depending on the mirror setting, are located on the DMD chip 50. The image emitted by the DMD chip 50 is finally imaged via the lens 52 on a screen 54. If the light that comes from the discharge lamp 42 and is coupled into the integrator 46 has been subjected to intensity fluctuations, this also results in intensity fluctuations of the image depicted on the screen.

When designing the projectors, it is therefore strived to form a projector which is as compact as possible and functions with a high level of efficiency, but also to minimize the fluctuations in the light intensity. Since the light-collecting system of the projector 40 with the integrator 46, the relay optical unit 48 and the DMD chip 50 is generally preset, the Étendue is also preset as a constant. Since the mirrors of the DMD chip 50 can generally be deflected through 12°, the acceptance angle of the DMD chip is correspondingly 120. Owing to the relay optical unit 48, this acceptance angle is widened, with the result that the acceptance angle of the light-collecting system is generally between 200 and 400. The Étendue of a DLP projector is provided by the following equation:

E=π·A_{DMD}(1+o)·sin²12°

A_{DMD} denotes the area of the DMD chip and o denotes the so-called DMD overfill.

With an imaging scale β of the relay optical unit 48, the area of the integrator is

$$A = \frac{{A}_{DMD} ( 1 + o )}{{β}^{2}} ;$$

and its acceptance angle is sin θ=β·sin 12°.

The luminous flux maximum is now defined, wherein an optimum acceptance angle in the range of between 20° and 40° results. The imaging scale β_{Opt} associated therewith for the relay optical unit is fixed thereby.

In order to minimize the influence of the arc movements in accordance with the invention, one of the following options can be implemented:

1. The imaging scale of the relay is reduced in size or the integrator area is selected so as to be correspondingly larger, as a result of which the acceptance angle θ is reduced in size.
2. On the other hand, it is naturally possible to keep the imaging scale of the relay the same, but to use an integrator which is conical instead of a straight integrator. The larger entrance area thereof is given by

$$A > \frac{{A}_{DMD} ( 1 + o )}{{β}^{2}}$$

and the exit area is given by

$$A = \frac{{A}_{DMD} ( 1 + o )}{{β}^{2}} .$$

As a result, the angle range of the light is increased in size and light with an acceptance angle of θ>arcsin(β·sin 12°) is sacrificed.
3. In principle, it is naturally also possible to equally enlarge the entrance and exit area given the same imaging scale of the relay optical unit. In this case, the image of the exit area on the chip is then greater than the exit area itself, as a result of which the percentage effective luminous flux loss is achieved again.

If the DLP projector is already provided as an existing system, the possibility of using a discharge lamp which is matched to the optimized values and has an individually set elliptical reflector (with a reduced numerical eccentricity than for optimum matching) likewise exists in accordance with the invention.

The invention discloses a method, and an optical system using this method, for compensating for fluctuations in the light intensity of a light which is emitted by a discharge lamp, is focused by a reflector and is coupled into a light-collecting optical unit with a defined Étendue at a defined acceptance angle, wherein the effective luminous flux maximum is defined depending on the Étendue, the acceptance angle and the reflector properties, and the reflector properties, the acceptance angle and/or the Étendue are matched in such a way that the effective luminous flux maximum is reduced by a definable percentage magnitude.

1. A method for reducing the effects of fluctuations in the light intensity of an effective light which is emitted by a discharge lamp, is focused by a reflector and is coupled into a light-collecting optical unit with a defined étendue at a defined acceptance angle, wherein the method comprises the steps of:
defining an effective luminous flux maximum depending on étendue, acceptance angle and/or reflector properties, and
changing the reflector properties, the acceptance angle and/or the étendue in such a way that the effective luminous flux maximum is reduced by a definable percentage magnitude.

2. The method as claimed in claim 1, wherein the percentage magnitude is in the range of 5%-20%.

3. The method as claimed in claim 1, wherein an element whose acceptance angle and coupling-in area bring about a reduction in the effective luminous flux maximum is connected upstream of the light-collecting optical unit.

4. The method as claimed in claim 3, wherein the upstream element is a conical glass or hollow body.

5. The method as claimed in claim 1, wherein, when using an elliptical reflector, the acceptance angle is reduced in size and the coupling-in area is increased in size in order to achieve the percentage reduction in the effective luminous flux maximum.

6. The method as claimed in claim 5, wherein the percentage reduction is achieved by virtue of a reduction in the numerical eccentricity of the reflector.

7. The method as claimed in claim 1, wherein, when using a parabolic reflector, the acceptance angle is increased in size and the coupling-in area is reduced in size in order to achieve the reduction in the effective luminous flux maximum.

8. An optical system comprising a discharge lamp, a reflector, which focuses the effective light of the discharge lamp in one spot, and a light-collecting optical unit with a defined Étendue, into which the effective light focused by the reflector is coupled at a defined acceptance angle, wherein the reflector and/or acceptance angle and/or Étendue are configured so that the effective luminous flux maximum of the coupled-in light is reduced by a definable percentage.

9. The optical system as claimed in claim 8, wherein the percentage magnitude is in the range of 5%-20%.

10. The optical system as claimed in claim 8, wherein an element whose acceptance angle and coupling-in area bring about a reduction in the effective luminous flux maximum is connected upstream of the light-collecting optical unit.

11. The optical system as claimed in claim 10, wherein the upstream element is a conical glass or hollow body.

12. The optical system as claimed in claim 1, wherein when using an elliptical reflector, the acceptance angle is reduced in size and the coupling-in area is increased in size in order to achieve the percentage reduction in the effective luminous flux maximum.

13. The optical system as claimed in claim 12, wherein the percentage reduction is achieved by virtue of a reduction in the numerical eccentricity of the reflector.

14. The optical system as claimed in claim 8, wherein, when using a parabolic reflector, the acceptance angle is increased in size and the coupling-in area is reduced in size in order to achieve the reduction in the effective luminous flux maximum.

15. The optical system as claimed in claim 1, wherein the optical system is a DLP projector, in which the light-collecting optical unit is formed by an integrator and a downstream relay optical unit, wherein the relay optical unit has a defined imaging scale, and the imaging scale is matched in such a way that the acceptance angle of the integrator is reduced.

16. The optical system as claimed in claim 8, wherein the optical system has an optical waveguide as the light-collecting optical unit.

17. The optical system as claimed in claim 16, wherein the optical system is an endoscope.

18. The optical system as claimed in claim 8, wherein the optical system is a microscope.

19. The optical system as claimed in claim 8, wherein the optical system is an LCD or LCOS projector.
